(19) United States
(12) Patent Application Publication
(10) Pub. No.: US 2014/0177951 A1
(43) Pub. Date: Jun. 26, 2014

(54) METHOD, APPARATUS, AND STORAGE MEDIUM HAVING COMPUTER EXECUTABLE INSTRUCTIONS FOR PROCESSING OF AN ELECTRONIC DOCUMENT

(71) Applicant: DOCUWARE GMBH, Germering (DE)

(72) Inventors: JUERGEN BIFFAR, GERMERING (DE); MICHAEL BERGER, GERMERING (DE); CHRISTOPH WEIDLING, MUENCHEN (DE); ANDREAS HOFMEIER, DACHAU (DE); DANIEL ESSER, DRESDEN (DE); MARCEL HANKE, BERLIN (DE)

(73) Assignee: DOCUWARE GMBH, Germering (DE)

(21) Appl. No.: 14/138,396

(22) Filed: Dec. 23, 2013

(30) Foreign Application Priority Data
Dec. 21, 2012 (DE) 102012025350.8

(51) Int. Cl. G06F 17/30; G06K 9/62; G06K 9/00

(52) U.S. Cl. CPC G06F 17/30253; G06K 9/00456; G06K 9/6254
USPC 382/161

(57) ABSTRACT

In a method for processing an electronic document, a database which is used to extract information relating to the document is adapted using the electronic document, and in which the database is adapted using at least one item of feedback from a user. Furthermore, an apparatus, a computer program product and a storage medium are accordingly specified.

### CROSS-REFERENCE TO RELATED APPLICATION

This application claims the priority, under 35 U.S.C. §119, of German application DE 10 2012 025 350.8, filed Dec. 21, 2012; the prior application is herewith incorporated by reference in its entirety.

### BACKGROUND OF THE INVENTION

### FIELD OF THE INVENTION

The invention relates to the processing of an electronic document, in particular the extraction of information from an electronic document.

Different text recognition (also referred to as optical character recognition (OCR)) methods which can be used to recognize text inside images in an automated manner are known. The images are, for example, electronically scanned documents, the content of which is intended to be analyzed further.

The indexing of documents, that is to say occupation of metadata fields for each document, is effected manually or using semi-automatic methods in many cases. Previous approaches read the documents by use of firmly defined rules, for example by analyzing particular rectangular areas of a document page, recognizing graphics or symbols and learning a fixed position of extracted data, or by script-based reading methods. For example, by stating fixed coordinate fields in the document, it is possible to search for contents which are then adopted. Alternatively, static rules are defined which extract information from the document after it has been read in. Systems which display the document to the user via a viewer are also known. The user can then mark areas from which text data for an index field are read.

The extraction of the data fields is preferably preceded by identification or classification of a document type. In this respect, reference is made, for example, to an article by Hu, J., Kashi, R., and Wilfong, G., entitled “Comparison and classification of documents based on layout similarity”, Information Retrieval 2 (2), 227-243 (2000)] or a reference by Daniel Esser, Daniel Schuster, Klemens Muthmann, Michael Berger and Alexander Schill, entitled “Automatic Indexing of Scanned Documents-a Layout-based Approach”, IS&T/SPIE Document Recognition and Retrieval XIX (DRR 2012), San Francisco, Calif., USA, 2012].

It is also known practice to use a training-based improvement of the automatically proposed indexing by Bayesian or neural networks which have already been pretrained by the manufacturer using a set of documents.

In this case, it is disadvantageous that the training or definition is inflexible. Another disadvantage of the rule-based solution is that it must be known in advance how documents should be read. For unknown document types, the rules must be subsequently adapted, which requires a large amount of administrative effort. The same applies to script-based methods: a creator of the script must know the document types to be read for which he is writing the script. For example, in order to extract the total amount of an invoice, it does not suffice to link a fixed position in a document to the amount if the latter is at the end of a table of variable length.

### SUMMARY OF THE INVENTION

The object is, in particular, to make it possible to extract data fields from a document in a flexible manner and as easily as possible even if only a small number of training documents are available, for example.

This object is achieved according to the features of the independent claims. Preferred embodiments can be gathered, in particular, from the dependent claims.

In order to achieve the object, a method for processing an electronic document is specified, in which a database which is used to extract information relating to the document is adapted using the electronic document.

The database is, for example, a data bank which may be central or decentralized and can be used to extract information, for example index data, relating to a document. In this case, the electronic document may be both the target for the extraction of information and a training document which is used to adapt, for example supplement, the database.

In this case, it is advantageous that the database can be adapted during ongoing operation that is to say during the processing of the electronic document for example, using the feedback from the user. Therefore, there is no need for a separate training phase which would have to take place independently of the processing of the electronic document. There is also no need for any complicated administration or adaptation of the database independently of the processing of electronic documents because the database is adapted to the users' requirements during ongoing operation, that is to say during use.

One development is that the feedback from the user contains a marking of at least one alphanumeric character, in particular at least one word, in the electronic document.

Another development is that the information determined from the feedback is used for indexing, the database being adapted using the information.

In particular, one development is that the information contains at least:

a position in the electronic document,
a marking, in particular an item of coordinate information, for an index value,
a keyword for the index value,
text of the marking and/or around the marking, in particular text above and/or to the left of the marking,
a distance between the index value and the keyword, and
the full text of the electronic document.

The keyword or marking can also be referred to as context. Context-based extraction attempts to find such contexts, in particular on the basis of previous inputs by the users which were determined using training documents and are stored in the database.

It is also a development that the information contains a context which has, in particular, at least one of the following parts:

context text,
a distance, and
an orientation.

The context text may be a word or a sentence which is situated around the index value in the training document and is intended to be searched for in an extraction document. The distance corresponds, for example, to a horizontal and/or vertical shift between the index value and the context text in the training document. The orientation can be used to determine, for example, whether the context text has been found above or to the left of the index value.

A development is also that the feedback from the user is effected to a central unit, the central unit containing the database or the database being able to be adapted using the central unit.

The feedback from the user can also be stored in a central database in addition to the user's own database. The database stores, for example, the documents themselves and/or information needed for indexing (OCR result, position of the index terms, etc.).

Many items of feedback from possibly a plurality of users may therefore be used, for example in a cross-organizational manner, to process electronic documents. This reduces the classification effort for each user and improves the classification results.

Within the scope of an additional development, the electronic document is an OCR-preprocessed document, the content of which is then present at least partially in the form of characters which can be electronically recognized and processed.

A next development involves the database being based on at least one training document and/or comprising data relating to at least one training document.

One refinement is that data fields are extracted from the electronic document using the database.

The data fields are also referred to as index data. The database can therefore be used to extract index data from the electronic document. It is additionally possible for the electronic document to itself become a training document using the adaptation of the database after the user has provided feedback on the index data of the electronic document which were used to adapt the database.

An alternative embodiment involves providing proposals for data fields extracted from the electronic document using the database.

A next refinement is that the data field has a fixed position or a variable position in the electronic document.

It is also a refinement that the database has information relating to at least one training document.

One development involves the information for each training document containing an index file with at least one item of feedback from a user for this training document, in particular containing a value of an identified data field and/or a position of the data field and/or a rectangle surrounding the data field.

An additional refinement is that a list of extraction patterns is produced for each training document using the index file.

In this case, the extraction pattern preferably contains a field name, a value in the training document and the coordinates of the surrounding rectangle. In this case, the extraction pattern may contain or take into account the context explained above.

Another refinement is that lines in the electronic document which are in a spatial vicinity of the extraction pattern are determined for each extraction pattern.

These may be both directly superimposed lines and lines in a certain (for example predefined) spatial vicinity of the extraction pattern.

It is also possible:

to rate candidate words for the lines for each extraction pattern according to a rating function, the rating function preferably taking into account a distance between the central points of the surrounding rectangles and/or a degree of overlap of the surrounding rectangles, and
to select the line in the electronic document with the highest sum of ratings of the candidate words present in the line for each extraction pattern.

The candidate words with the best rating can preferably be inserted into a set of results as proposals for each selected line. In this case, all words whose ratings are above a certain threshold value are inserted, for example. All words in a line which are above the threshold value form a result proposal. Furthermore, the result proposals from the test document (the electronic document to be classified) can each be grouped with respect to field names. An ordered list of result proposals may be output, for example, for each field name. The list may be sorted in descending order, for example, according to the sum of the word ratings in the result proposal (based on the distance and/or degree of overlap).

The above mentioned object is also achieved by an apparatus for processing an electronic document, having a processing unit which is set up in such a manner that a database which is used to extract information relating to the document can be adapted using the electronic document.

The processing unit mentioned here may be, in particular, in the form of a processor unit having a memory, a computer or a distributed system of processor units or computers. In particular, the processing unit may have computers which are connected to one another via a network connection, for example via the Internet.

The database may be a data bank or a data bank management system which is part of the processing unit or separate from the latter. In particular, both the processing unit and the database may be central or may have at least one central component. A decentralized implementation is also accordingly possible.

In particular, the processing unit may be or contain any type of processor or computer with accordingly necessary peripherals (memory, input/output interfaces, input/output devices, etc.).

The above explanations relating to the method accordingly apply to the apparatus. The apparatus may be in one component or distributed in a plurality of components.

The abovementioned object is also achieved by a system containing at least one of the apparatuses described here.

The solution presented here also contain a computer program product which can be loaded directly into a memory of a digital computer, containing program code parts which are suitable for carrying out steps of the method described here.

The abovementioned problem is also solved by a computer-readable storage medium, for example any desired memory, containing instructions (for example in the form of program code) which can be executed by a computer and are suitable for the computer to carry out steps of the method described here.

Other features which are considered as characteristic for the invention are set forth in the appended claims.

Although the invention is illustrated and described herein as embodied in a processing of an electronic document, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic diagram illustrating an overview of a solution for extracting data fields in a document according to the invention; and

FIG. 2 is an illustration showing, by way of example, an excerpt from an invoice with a layout comprising an invoice number.

### DETAILED DESCRIPTION OF THE INVENTION

In the present case, flexible and adaptable indexing of imported documents in a document management system is proposed, for example. The imported documents may be scanned documents or documents stored using a file system, for example invoices, requests, delivery notes, etc. In this case, the imported documents have recognizable characters or character strings (also referred to as “text”) which can be electronically searched for. If necessary, a text recognition process has been previously carried out for this purpose, for example using OCR software. In this case, it is mentioned that the “characters” or “text” can relate to any contents which can be searched for by a processing unit, including, for example, alphanumeric characters in different languages, symbols, special characters, punctuation marks, etc. For example, mathematical or chemical notations may also possibly contain characters in the abovementioned sense.

Data are extracted from a document and are offered to the user for selection and, for example, for use during indexing. Such data may be, for example, a sender, a recipient, an invoice amount, a date or the like.

A training-based method for automatically proposing index data uses, for example, algorithms which can evaluate user inputs for selecting the extracted data. The user provides his feedback (for example using electronic input device on a computer) on data offered for indexing in an automated manner (this is also referred to as a point & shoot method below); the feedback is used to train an algorithm, with the result that subsequent similar documents can already be analyzed taking this feedback into account and indexing proposals can accordingly be provided in an automated manner. If the user also provides his feedback on these proposals, the proposals provided by the algorithm become iteratively better and better.

The training can be carried out for each user and/or for each organization. A service which provides a proposal for all users requesting this service can also additionally be trained.

The solution proposed here makes it possible for the user to interactively give his feedback based on a document and thus to improve a recognition or assignment algorithm. It is also possible to flexibly provide or implement user-based training across organizational boundaries.

In particular, it is therefore proposed to use the feedback from the user by making it possible for the latter to mark or highlight positions of the words in a document. The information obtained therefrom is used for indexing by virtue of the algorithm learning, for example, the markings or the coordinates associated with a marking in a document. Such markings or coordinates can then be automatically used for the next similar document.

It is also an option to access documents in a cross-organizational manner and for different users to provide a central entity with feedback for different (possibly also identical) document types. The algorithm is therefore trained by a multiplicity of users. This is advantageous, for example, for a user who only rarely wishes to process a particular document type since this document type is highly likely to have already been provided with markings by a different user and the markings can therefore be provided by the central entity without further training. The indexing proposals which can already be provided by the central entity therefore improve the extraction result for a user wishing to index this document type for the first time.

Point & shoot is understood as meaning, in particular, that a user makes a marking in the document; the text of the marking is extracted and is possibly linked to an index field by the user (or automatically). For example, the user can click on a date in a document and can mark the character string of the date. The position of the character string is stored and the character string is extracted. The user can additionally give the extracted character string the name “invoice date”. The algorithm therefore knows the position of an “invoice date” field in the other documents of the same type and can already provide the user with the invoice date, as an item of information which can be extracted from the document, in an automated manner in such documents.

The document to be processed can be scanned, for example, or may already be in the form of a document which can be processed electronically (for example a searchable PDF document).

It is also possible for a multiplicity of characters and/or words to each be stored with the position of this character or word. The position can also be stored with a predefined vagueness, that is to say a permissible deviation.

The marking can be made by the user, for example, by moving an input device (for example a mouse or an input device on a touch-sensitive screen (touchscreen)) over the displayed document and carrying out highlighting (for example of the character or a multiplicity of characters), whether by a border with a box or in the form of a text marking. The input device can therefore be used to mark characters or words, for example, and to adopt them, as an index value, in a metadata field (for example “invoice date”).

Online training with user feedback is now described.

The extracted information such as text, position, effects, highlighting (for example bold and/or italics) and areas recognized by OCR software (also referred to as OCR areas) are supplied to training (for example a relevant algorithm) which is used to learn specific properties of this document or document type. Segmentation (also referred to as clustering) can also be carried out and index data can be read at particular positions and/or by predefined rules using the algorithm.

The user can train the system using point & shoot. In this case, the document in an exchange format (possibly not the original document) and the feedback data (for example positions at which the characters or words detected by the user are situated), for example, can be transferred to the learning system and processed by the latter. The system then searches for the “most similar template” (or a particular number of the most similar templates, where the number can vary in a range of 1 to 5, for example) in a next document and evaluates the user feedback, the specially marked positions and characters or words in that case. The feedback from the user is therefore efficiently used for similar documents. Further feedback results in the results of the automated extraction becoming better.

A hierarchical approach is now described.

Finally, a user who has never trained a particular document type can access the training already carried out by other users (for example via a central entity or a central database), with the result that not every user has to train all of his document types himself. This is advantageous, in particular, because a multiplicity of similar document types can therefore be trained in a distributed manner by many users and all users are provided with the result of the distributed training.

In the case of cross-organizational training, the documents and the feedback are therefore forwarded to the super ordinate entity which is then likewise trained. This entity may likewise be queried with respect to its classification and the index data.

Further advantages are now described.

The approach makes it possible to improve the extraction quality for documents to be subsequently classified as a result of the possibility of feedback on the basis of the data marked by the user (characters, character strings, words, sentences, logos, etc.) in the document. Positions of the markings, for example, are used for the automated extraction training.

A central entity can be efficiently trained by forwarding document exchange formats and the items of feedback from the users. The central entity may be queried, for example, by a local application and can thus provide the knowledge or feedback from many users relating to a multiplicity of documents or document types.

One advantage of the point & shoot approach is that the user can mark data in the document by a selection (for example by typing on the touch screen or by clicking the mouse) and can therefore adopt the data as an index field.

The advantage of the feedback based on the point & shoot approach also lies in the fact that the user marks only the characters or character strings to be extracted in a document and automatically receives these data at the positions linked to the previous marking in further documents of the same type. As a result, the user therefore adds rules and corrects existing rules. A new document of the same type can therefore be read with a greater degree of accuracy and in a manner adapted to the user's requirements. In this case, there is no need for any training by an administrator or a manufacturer.

In the cross-organizational approach, the document and the feedback from a multiplicity of users are also forwarded to a central entity. The latter is therefore trained by all users. The data stock of the database which can be accessed by a user wishing to use the extraction method for the first time or wishing to extract a new document type for the first time therefore increases. The likelihood of another user already having provided the central entity with feedback on this document type and of that user who wishes to process a document of this type for the first time being provided with information which (largely) corresponds to his needs for extracting information in the form of information relating to index fields which has already been used and filled from the document is therefore high.

Training-based extraction of data fields of electronic documents is now described.

The present proposal allows data fields (also referred to as index fields or metadata fields) such as sender, recipient, payment amount, etc. to be automatically extracted from an electronic document, for example a scanned or photographed document.

In this case, the data fields were preferably created using a so-called template. A template places certain data fields from a data memory in a layout such that the position of the fields may be fixed (for example sender) or variable (for example invoice amount). A multiplicity of business documents or forms (invoices, delivery notes, etc.) have templates in this sense.

However, the solution presented here is not restricted to such documents, but rather can also be applied to forms (for example prescriptions) or other documents (for example till receipts).

At the beginning of the method, there is a so-called test document for which data fields are intended to be automatically recognized. The document is in the form of characters or words and has been preprocessed, possibly using an OCR program, for this purpose. The lines and words of the document and the positions of the characters or words on the document page are therefore known. Such a representation of the document page is provided by existing OCR programs, for example.

There are also a multiplicity of training documents for which the creator of the document preferably used the same template as for the test document. A list of training documents can preferably be provided by an upstream template identification process (see the article by Daniel Esser, Daniel Schuster, Klemens Muthmann, Michael Berger and Alexander Schill, titled “Automatic Indexing of Scanned Documents—a Layout-based Approach”, IS&T/SPIE Document Recognition and Retrieval XIX (DRR 2012), San Francisco, Calif., USA, 2012]).

Template identification is carried out with a certain uncertainty. The method presented here should therefore preferably be configured such that a training document which is occasionally identified as erroneous can be tolerated.

For each training document, an index file with feedback from at least one user for this document can also be specified, for example, in addition to the OCR representation of the training document. In addition to the value of the respective data field, the positions of the fields (surrounding rectangle) are also known.

The extraction of the data fields can therefore comprise at least some of the below described steps.

1. For each training document, a list of extraction patterns is generated from the details in the index file. The extraction pattern contains a field name, a value in the training document and the coordinates of the surrounding rectangle.
2. For each extraction pattern, all lines in the test document which are in the spatial vicinity of the extraction pattern (candidate lines) are determined. These are both directly superimposed lines and lines in a certain (for example predefined) spatial vicinity of the extraction pattern.
3. For all candidate lines determined, all candidate words are rated according to a rating function for each extraction pattern.
4. The rating function uses the distance A between the central points of the surrounding rectangles and/or the degree of overlap of the surrounding rectangles according to a formula (rating function):

$$score = \frac{{A}_{Template} ⋂ {A}_{Test}}{{A}_{Template} ⋃ {A}_{Test}} ,$$

where A_{Template} is a distance from the training document and A_{Test} is a distance from the test document.
5. For each extraction pattern, the line in the test document with the highest sum of ratings of the words contained in said line is selected.
6. For each selected line, the best words are inserted into a set of results as a proposal. In this case, all words whose ratings are above a certain threshold value are inserted, for example. All words in a line which are above the threshold value form a result proposal.
7. The result proposals from the test document are each grouped with respect to field names. An ordered list of result proposals is output for each field name. The list is sorted in descending order according to the sum of the word ratings in the result proposal (based on the distance and/or degree of overlap).
8. In the case of proposals with the same value from a plurality of training documents, majority voting is used, for example, in addition to the measures from No. 4 in order to accordingly give these values a higher rating. The highest word rating provided by an algorithm can be used, for example, in majority voting. Alternatively or additionally, the average could also be used or a more complex method could be used.
9. For each field, result proposals are returned, for example, only when they exceed a certain threshold value.

The present proposal makes it possible to generate extraction rules from known training documents. A layout-based procedure is proposed, in particular in conjunction with the rating function.

The approach allows the extraction of data fields already in an individual known training document of the same type. A higher degree of accuracy is achieved with a plurality of training documents (for example 2 to 5).

Another advantage is that threshold values are preferably determined in advance according to the above statements. There is no need for further configuration. The solution presented quickly adapts to the user's needs and to new and amended training documents.

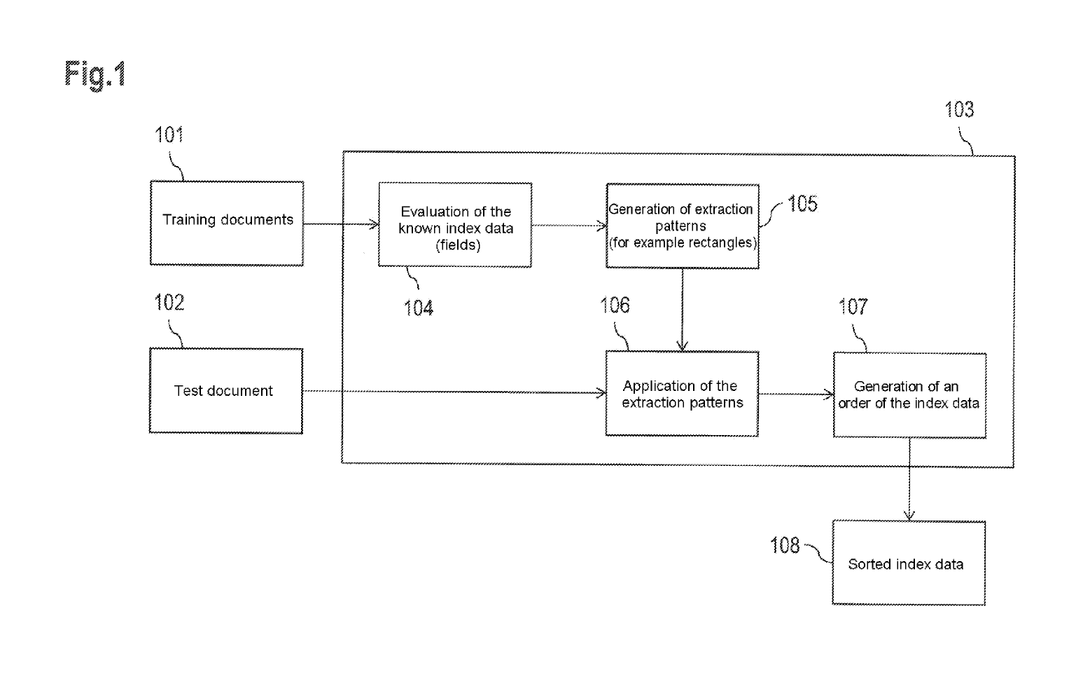

FIG. 1 shows a schematic diagram illustrating an overview of a solution for extracting data fields in a document.

By way of example, training documents 101 are supplied to an index data extraction unit 103. For each training document, known index data (or fields) are evaluated (see step 104) and extraction patterns are generated (see step 105). A test document 102 to be classified is supplied to the index data extraction unit 103 and the generated extraction patterns are applied to the test document in a step 106. On the basis of this, an order (also referred to as “ranking”) of the index data is generated in a step 107 (for example using the rating function) and index data sorted by the index data extraction unit 103 are provided in a step 108.

A further embodiment for context-based extraction is now described.

Context-based extraction contains a learning algorithm which can be used to extract index data from a document.

If index data are extracted from the document, the algorithm uses similar documents whose index data are already known (that is to say have been verified by users, for example).

By way of example, the document whose index data are intended to be extracted is referred to as an extraction document (also: test document). Documents which are accessed during the extraction operation are referred to as training documents.

As soon as a certain index value is intended to be extracted from the extraction document, the algorithm looks up the corresponding index value in the at least one training document. Specifically, a context of the index value in the respective training document is stored, that is to say text around the index value in the training document and/or a distance between this text and the index value, for example. This text is searched for in the extraction document. If the text is found, a possible candidate (possibly also a plurality of candidates) for the index value is located in the extraction document with the aid of the distance information.

One example for context-based extraction is now described.

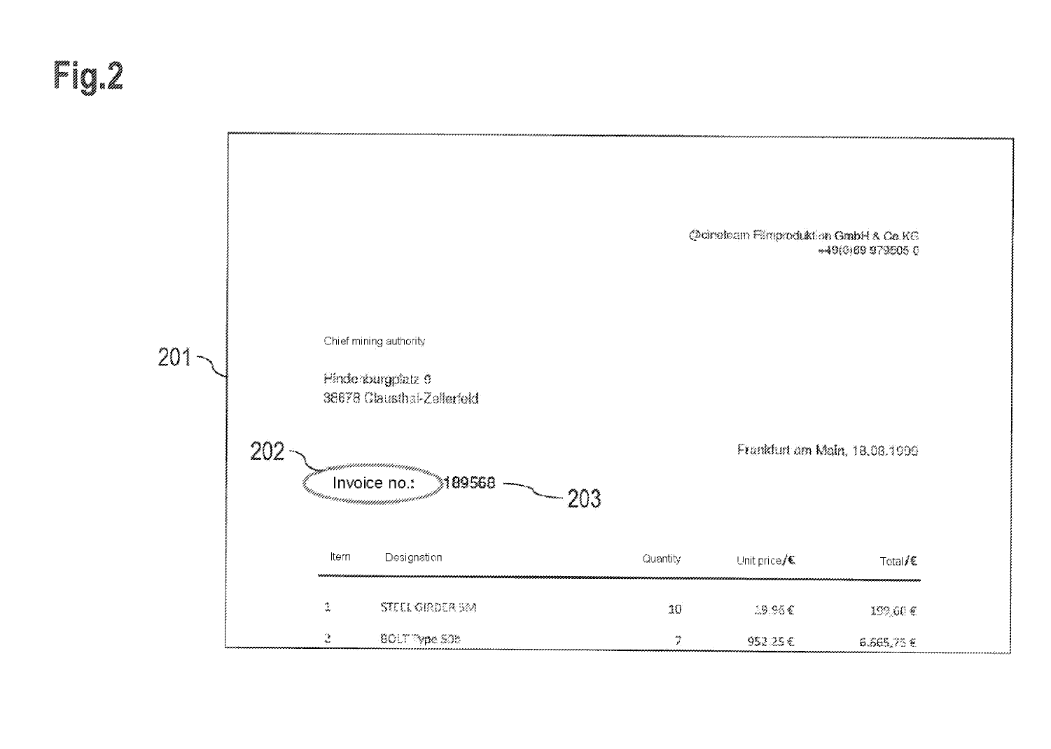

FIG. 2 shows, by way of example, an excerpt 201 from an invoice with a layout containing an invoice number. The aim of context-based extraction according to this example is to extract the invoice number as an index value (with the highest possible reliability).

A typical feature of the invoice is the word “Invoice no.:” 202 which is in the vicinity of, in particular beside or above, the index value “189568” 203 to be extracted. The word “Invoice no.:” can therefore be used as a keyword or marking for the index value “189568” to be extracted. This word is also referred to as context here, by way of example. Context-based extraction attempts to find such contexts (markings), in particular on the basis of previous inputs by the users.

As soon as the user marks the invoice number as an index value in a document, the document can be used in future as a training document. Text around the marked position is also stored. For example, the text to the left of and/or above the index value is stored. Since the document has preferably been preprocessed beforehand, for example using OCR software, the characters and character strings of the document are available and can accordingly be stored (in the case of an electronic document which was created using word processing, for example, and was stored in a corresponding format, it is possible to dispense with the OCR processing because the individual characters and character strings are already accessible; in this case, format conversion into a format which can be accessed and stored by the software can be carried out). In the above example, this relates to the (key)word “Invoice no.:” above the index value “189568”.

The keyword is stored, together with the information relating to the distance from the index value, in a data bank, for example. The text of the document is preferably also stored in full text so that the complete document can be used as a training document.

As soon as the user wishes to extract the invoice number from a further invoice as an extraction document (that is to say a further document with a layout which is already known), the algorithm uses the document text of the extraction document to find similar documents in the data bank which can be used as training documents.

If at least one such training document is found, the associated stored contexts are read from the data bank. The keywords of the contexts are now searched for in the text of the extraction document. As soon as a keyword (“Invoice no.:” in the above example) is found, the position in the extraction document at which a candidate for the index value should or could be is determined with the aid of the stored distance information.

The implementation example for context-based extraction is now described.

For example, a context can be realized as a tuple with:

a) context text, that is to say a word or a sentence, which is situated around the index value in the training document and is intended to be searched for in the extraction document;
b) a distance, for example a horizontal and/or vertical shift, between the index value and the context text in the training document; and
c) an orientation which can be used to determine whether the context text has been found above or to the left of the index value.

Scanned document processed using OCR software is preferably provided in advance. Such a preprocessed document preferably contains a layout which has been analyzed, for example words and lines with coordinate for the locations at which they occur.

A full text search index can optionally be used to find similar documents. If a document is provided with index data by the user, the full text content of the document is stored in a manner linked to this index, for example. In order to find similar documents for an index, the words of a document can be combined to form a search query, for example. The full text search returns those training documents which are the best results of the search query first.

Different methods can be used to determine the left-hand context and the upper context of an index value, for example.

If the user marks the index value, the algorithm receives the OCR result of the marking and the marked position as an input. Algorithms for finding the contexts for an individual index value are explained by way of example below. The algorithms can preferably be used for each field marked by the user.

The OCR result of the document and a rectangle R=(L,T,W,H) are used as input values for the algorithm. The output is a left-hand context or an upper context. The four parts of the rectangle define the left-hand side (L), the upper side (T), the width (W) and the height (H). All geometric values are given in the unit of measurement of twips, where one inch corresponds to 1440 twips.

The determination of the left-hand context of an index value of the training document is now described.

1. Use the input rectangle R to generate a new rectangle R2 whose right-hand side coincides with the left-hand side of R and which reaches the left-hand edge of the side: R₂=(0, T, L, H). The left-hand context is searched for inside R_{2.}

2. Increase the height of R₂ by 1% of its width. This prevents a context from being missed on account of a blurred OCR result:

T2=T2−(0.005*W2),

H2=H2+(0.01*W2).

3. Find all lines which at least partially overlap the rectangle R₂ in the OCR result.

4. For each line or its rectangle Rᵢ=(Li, Ti, Wi, Hi): find the line having the greatest overlap with R₂. That line whose range [Ti, Ti+Hi] has the greatest overlap with the range [T2, T2+H2] is therefore searched for. In the case of a plurality of lines with the same overlap, the line with the right-hand side farthest to the right is selected. The corresponding line is denoted L*.

5. Run through the words in the line L* from right to left until a distance of more than 750 twips occurs between two words. All words which have been run through up to this time form the left-hand context of the index value. If a sufficiently large distance does not occur, all words from the line L* are selected as the left-hand context.

6. A rectangle R₃=(L3, T3, W3, H3) around the context is determined. Distance information relating to the context is calculated on the basis of this, that is to say

dx=L₂−L₃, dy=T₂−T₃.

7. The rectangle R3, the text inside the rectangle R3 and the distance information are returned as the result.

We now describe how to determine the upper context of an index value of the training document.

1. Determine the rectangle in which the upper context is searched for:

R₂=(L, T-5*H, W, 5*H). This means that the upper context is searched for within a limited area above the index value. This is a difference to calculating the left-hand context in which the rectangle is bounded to the left of the side edge.

2. Find all lines which at least partially overlap the rectangle R₂ in the OCR result.

3. Select the line L* with the lowermost lower edge.

4. Run through the words from the line L* from right to left until a distance of more than 750 twips occurs between two words. All words which have been run through up to this time form the upper context of the index value. If a sufficiently large distance does not occur, all words from the line L* are selected as the left-hand context.

5. A rectangle R₃=(L₃, T₃, W₃, H₃) around the context is determined. Distance information relating to the context is calculated on the basis of this, that is to say

dx=L₂−L₃, dy=T₂−T₃.

6. The rectangle R3, the text inside the rectangle R3 and the distance information are returned as the result.

We now check whether a context can be used.

The output of the algorithms is checked by running through the document and checking whether the context occurs more than once. If the context occurs only once, the context is stored. If the context occurs at least twice, the context is stored only when the “true” context (that is to say the actually correct context) is the first or last occurrence of the context in the document. If this is the case, the fact of whether the “true” context was the first or last occurrence in the document is also stored. If the context occurs at least twice and the “true” context is not the first or last occurrence in the document, the context is not stored. In this case, it can be expected that the context also occurs repeatedly in an extraction document and it is not possible to ascertain which occurrence corresponds to the “true” context.

The extract index values from an extraction document are now described.

The extraction contains, in particular, the following steps:

1). Find similar documents whose index values have already been confirmed by the user.
2). Find candidates for the index values.

The algorithm returns a set of candidates for each index field. A downstream combination algorithm then calculates the candidate which is most likely to be correct for an index value.

The finding of similar documents now described,

The text content of the OCR result of the extraction document forms the input for the full text search index. The search index returns training documents whose index data have already been confirmed by the user and which are similar to the extraction document. A selection of those training documents which best match the extraction document (that is to say the n best training documents, with n=5, for example) is returned, for example. A similarity measure, for example a (multidimensional) distance, can be used as a measure of the correspondence between the training document and the extraction document.

The extract index values with the aid of a context are now described.

If an index value is intended to be extracted from a training document and if there are training documents in which context information is available, context-based extraction provides a result.

For an individual index field for which context information is available in a training document, context-based extraction operates as follows:

1. A check is carried out in order to determine how often the context occurs in the document. If the context does not occur, nothing is returned. If the context occurs more than once but no information is available as regards whether the “true” context corresponds to the first or last occurrence in the training document, nothing is likewise returned. If the context occurs only once or if an item of information is available as regards whether the “true” context corresponds to the first or last occurrence of the context in the training document, the method is continued and the occurrence of the context is applied to the extraction document. If the context occurs repeatedly, the correct occurrence is determined using the information as regards whether the “true” context corresponded to the first or last occurrence of the context in the training document.

2. The distance information relating to the context is used to find the point at which the left-hand upper corner of the rectangle is situated around the index value.

3. A rectangle of the same size as the rectangle around the index value in the training document is spanned and all words which are inside this rectangle are returned as candidates for an index value.

An entire line extension is now described.

If an index value in the training document corresponds exactly to an entire line, this information is also stored. This information is used whenever index data are extracted from an extraction document with the aid of this document. Step 3) from the above method is then modified as follows.

3. A rectangle of the same size as the rectangle around the index value in the training document is spanned. If the index value in the training document included an entire line, a check is carried out in order to determine whether exactly one line overlaps the rectangle. If this is the case, the words in this line are returned as a candidate for the index value, otherwise nothing is returned.

Further advantages and refinements are now described.

Context-based extraction preferably uses the left-hand and upper contexts of an index value. The right-hand and lower contexts can be additionally or alternatively used.

The left-hand and upper contexts of an index value are used separately in the extraction document, for example. The element to the right of the left-hand context is therefore returned as a candidate for the index value. The element below the upper context is accordingly returned as the index value. The elements need not be identical in this case.

For example, a different quality value may be assigned depending on the context: for example, the left-hand context may be more reliable than the upper context, as a result of which the left-hand context is given a higher quality value. Candidates for an index value which were determined with the left-hand context can therefore be given a higher quality value than candidates determined with the upper context.

If a user inputs or confirms the index values of a document, the context information is searched for and stored. As soon as the document is then used as a training document, the information can be used without the document having to be processed again.

The contexts can preferably be stored in “corrected” form, for example by removing numbers and special characters from the start and end of a word.

Although the invention was described and illustrated in more detail using the at least one exemplary embodiment shown, the invention is not restricted thereto and other variations can be derived therefrom by a person skilled in the art without departing from the scope of protection of the invention.

1. A method for processing an electronic document, which comprises the steps of:
adapting a database, which is used to extract information relating to the electronic document, via the electronic document; and
adapting the database using at least one item of feedback from a user.

2. The method according to claim 1, wherein the item of feedback from the user contains a marking of at least one alphanumeric character in the electronic document.

3. The method according to claim 2, which further comprises:
using information determined from the item of feedback for indexing; and
adapting the database using the information determined from the item of feedback.

4. The method according to claim 3, wherein the information contains at least one of: a position in the electronic document, a marking for an index value, an item of coordinate information for the index value, a keyword for the index value, text of the marking, text around the marking, a distance between the index value and the keyword, and a full text of the electronic document.

5. The method according to claim 3, wherein the information contains a context which has at least one of the following parts: a context text, a distance, or an orientation.

6. The method according to claim 1, wherein the item of feedback from the user is effected to a central unit, the central unit containing the database or the database being able to be adapted using the central unit.

7. The method according to claim 1, wherein the electronic document is an optical character recognition (OCR) preprocessed document, a content of the electronic document is then present at least partially in a form of characters which can be electronically recognized and processed.

8. The method according to claim 1, wherein the database is based on at least one training document and/or contains data relating to the at least one training document.

9. The method according to claim 1, which further comprises extracting data fields from the electronic document using the database.

10. The method according to claim 9, which further comprises providing proposals for the data fields extracted from the electronic document using the database.

11. The method according to claim 9, wherein the data field has a fixed position or a variable position in the electronic document.

12. The method according to claim 1, wherein the database has information relating to at least one training document.

13. The method according to claim 12, wherein the information for each said training document contains an index file with the at least one item of feedback from the user for the training document, including containing a value of an identified data field, a position of the data field, and/or a rectangle surrounding the data field.

14. The method according to claim 13, which further comprises producing a list of extraction patterns for each said training document using the index file.

15. The method according to claim 14, which further comprises determining lines in the electronic document which are in a spatial vicinity of an extraction pattern for each said extraction pattern.

16. The method according to claim 15, which further comprises rating candidate words for the lines for each said extraction pattern according to a rating function, the rating function taking into account a distance between central points of the surrounding rectangles and/or a degree of overlap of the surrounding rectangles, in which the line in the electronic document with a highest sum of ratings of the candidate words present in said line is selected for each said extraction pattern.

17. The method according to claim 1, wherein the item of feedback from the user contains a marking of at least one word in the electronic document.

18. The method according to claim 3, wherein the information contains at least one of: a position in the electronic document, a marking for an index value, an item of coordinate information for the index value, a keyword for the index value, text of the marking, text around the marking namely text above and/or to the left of the marking, a distance between the index value and the keyword, and a full text of the electronic document.

19. An apparatus for processing an electronic document, the apparatus comprising:
a processing unit set up in such a manner that a database which is used to extract information relating to the electronic document can be adapted using the electronic document.

20. Computer executable instructions to be loaded into a non-transitory memory of a digital computer, for performing a method for processing an electronic document, which comprises the steps of:
adapting a database, which is used to extract information relating to the electronic document, via the electronic document; and
adapting the database using at least one item of feedback from a user.

21. A non-transitory computer-readable storage medium having computer executable instructions to be executed by a computer for performing a method for processing an electronic document, which comprises the steps of:
adapting a database, which is used to extract information relating to the electronic document, via the electronic document; and
adapting the database using at least one item of feedback from a user.
